(19) United States
(12) Patent Application Publication
(10) Pub. No.: US 2017/0003460 A1
(43) Pub. Date: Jan. 5, 2017

(54) HI-FI AUDIO SIGNAL OPTICAL FIBER CABLE

(71) Applicant: YU-FENG CHENG, New Taipei City (TW)

(72) Inventor: YU-FENG CHENG, New Taipei City (TW)

(21) Appl. No.: 14/790,264

(22) Filed: Jul. 2, 2015

(51) Int. Cl. G02B 6/40; G02B 6/44; G02B 6/06

(52) U.S. Cl. CPC G02B 6/40; G02B 6/06; G02B 6/4415; G02B 6/443

(57) ABSTRACT

A Hi-Fi audio signal optical fiber cable has an optical fiber bundle provided coaxially inside a snake tube. The optical fiber bundle has multiple optical fibers. Both ends of the optical fiber bundle protrude from the snake tube and are installed with a connector respectively. An air gap is formed between the optical fiber bundle and the snake tube so that ordinary air fills in the air gap. When a signal source inputs an optical signal via one connector, the optical signal is transmitted within each optical fiber by total reflection and goes out from the other connector. Since the refractive indices of the optical fiber bundle and the air have a significant difference, the total reflection is better, thereby achieving high fidelity. Each optical fiber has a smaller numerical aperture, and the optical path of the optical signal is shorter and signal attenuation in the material is avoided.

### BACKGROUND OF THE INVENTION

1. Field of the Invention

The invention relates to an optical fiber cable and, in particular, a Hi-Fi audio signal optical fiber cable that has an optical fiber bundle and an air gap filled with atmospheric air to increase the rate of total reflection.

2. Description of Related Art

As manufacturers of electronic products advocate the evolution of digital homes, people have higher demands about high-quality audio-video (AV) signals. Industries and markets of AV capture devices (single-lens cameras, video recorders, audio recorder, etc.), AV processing devices (personal computers, cloud servers, etc.), and AV output devices (high definition digital televisions) become prosperous. Suffering from electromagnetic and material wearing of ordinary cable lines, traditional analog audio signal transmission is likely to lose fidelity. It is thus difficult to realize high fidelity on normal AV terminal devices. Therefore, SONY, Philips, and other related companies developed the transmission interface of Sony/Philips Digital Interface Format (S/PDIF) in the 1980s. Based on the S/PDIF, the analog audio signal is encoded into an optical signal. Optical fibers were used as the transmission media for transmitting the optical signal to a decoder of an AV terminal device. Because the optical signal transmitted via the optical fiber is completely digitized, there is few problem in material or electromagnetic wearing that exists in cable lines. Therefore, using optical fibers to transmit audio signals can ensure a lower loss and distortion rate between the signal source and the AV terminal device. As a result, the audio signal has higher fidelity. This technology is widely used in high audio quality systems such as digital theater systems (DTS) and Dolby Digital.

With reference to FIG. 7, a conventional audio signal optical fiber cable has a single-core optical fiber 40, an optical fiber film 41, and a snake tube 42. The single-core optical fiber 40 has two opposite ends. The surface of the single-core optical fiber 40 is enclosed in sequence by the optical fiber film 41 and the snake tube 42. Both ends of the single-core optical fiber 40 protrude from the ends of the optical fiber film 41 and the snake tube 42. In practical application, both ends of the single-core optical fiber 40 are connected to an optical signal source and an AV terminal device, respectively. When the optical signal source encodes an analog audio signal into an optical signal and transmits it to one end of the single-core optical fiber 40, the optical signal is transmitted via the single-core optical fiber 40 by total reflections to the other end. The AV terminal device then decodes the received optical signal into a compatible audio signal. This achieves the goal of high fidelity audio signal transmission.

The optical fiber film 41 in this case is polyethylene (PE) whose refractive index is about 1.52. The refractive index of an ordinary single-core optical fiber 40 is about 1.47. Therefore, the difference in the refractive indices of the optical fiber film 41 and the single-core optical fiber 40 is not big. From Snell's Law in optics, it is known that the critical angle for total reflection is larger as the optical fiber film 41 tightly covers the surface of the single-core optical fiber 40. As a result, the total reflection rate of the optical signal in the single-core optical fiber 40 is lower due to the energy dissipation. The single-core optical fiber 40 needs a larger numerical aperture in order to transmit a sufficient volume of data. Therefore, the optical signal transmitted in the single-core optical fiber 40 has a longer optical path, which in turn results in more attenuation. It is therefore imperative to improve the structure of the audio signal optical fiber cable.

### SUMMARY OF THE INVENTION

In view of the foregoing, an objective of the invention is to provide a Hi-Fi audio signal optical fiber cable that has a better total reflection rate and a smaller numerical aperture. The optical signal transmitted therein has a lower attenuation rate, thereby achieving Hi-Fi signal transmission.

To achieve the above-mentioned objective, the disclosed Hi-Fi audio signal optical fiber cable includes:

a snake tube having two opposite openings;

an optical fiber bundle disposed coaxially inside the snake tube and having an air gap formed between the optical fiber and the snake tube along a radial direction, the optical fiber bundle comprising a plurality of optical fibers disposed in parallel and having two ends extending outside the openings on two ends of the snake tube;

two connectors mounted respectively on the two ends of the optical fiber bundle and exposed from the two openings of the snake tube.

According to the disclosed Hi-Fi audio signal optical fiber cable, the air gap is formed between the bundled optical fiber and the snake tube. The air gap is filled with atmospheric air, such that the refractive index has a significant change from the interior of the optical fiber bundle to the outer environment in the radial direction. This enables better total reflections for the optical signal. Moreover, since each of the optical fibers of the optical fiber bundle has a smaller numerical aperture, this renders a shorter optical path for the optical signal, avoiding attenuation inside the material.

### BRIEF DESCRIPTION OF THE DRAWINGS

FIG. 1 is a perspective view of a hi-fi audio signal optical fiber cable of the invention;

FIG. 2 is an exploded view of the invention;

FIG. 3 is a cross-sectional view of a connector of the invention;

FIG. 4 is a cross-sectional view of the connector of the invention;

FIG. 5 is an enlarged axial cross-sectional view of the invention;

FIG. 6 is a schematic view showing the principles of the invention; and

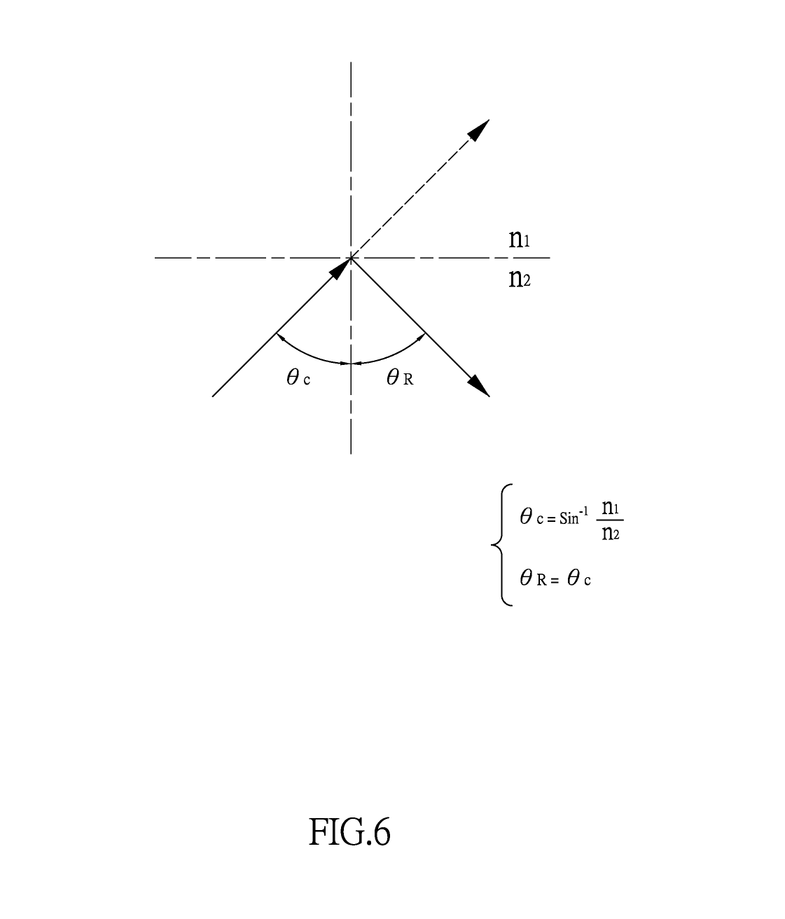

FIG. 7 is a partial cross-sectional view of an audio signal optical fiber cable in the prior art.

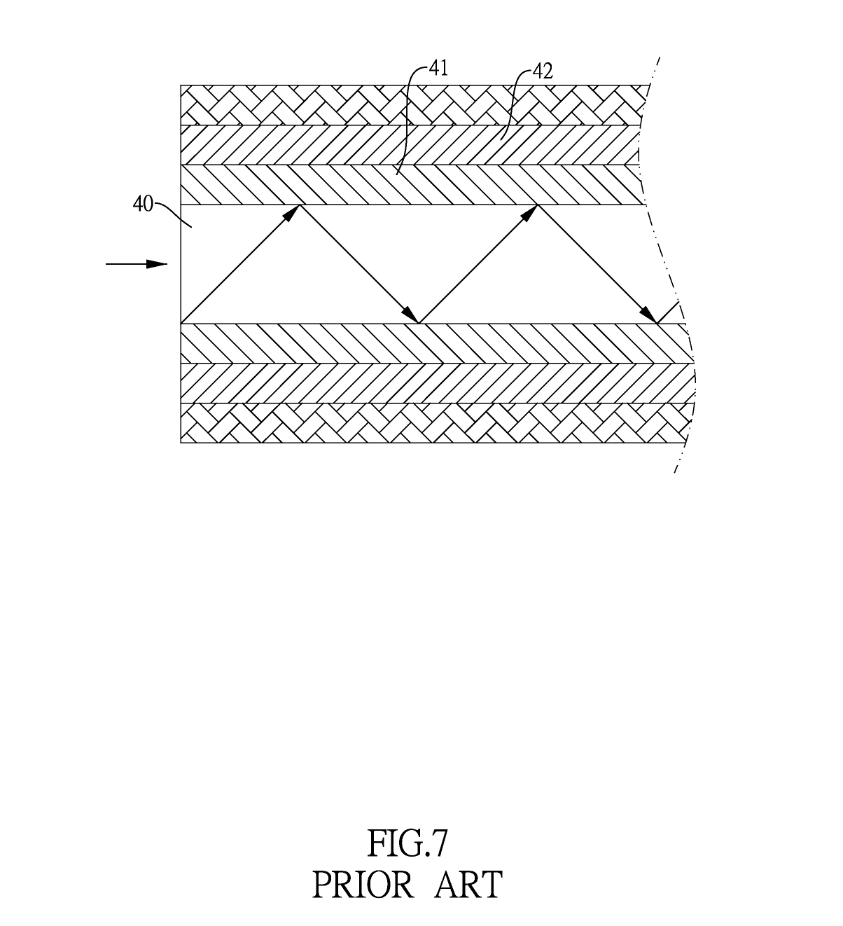

### DETAILED DESCRIPTION OF THE EMBODIMENT

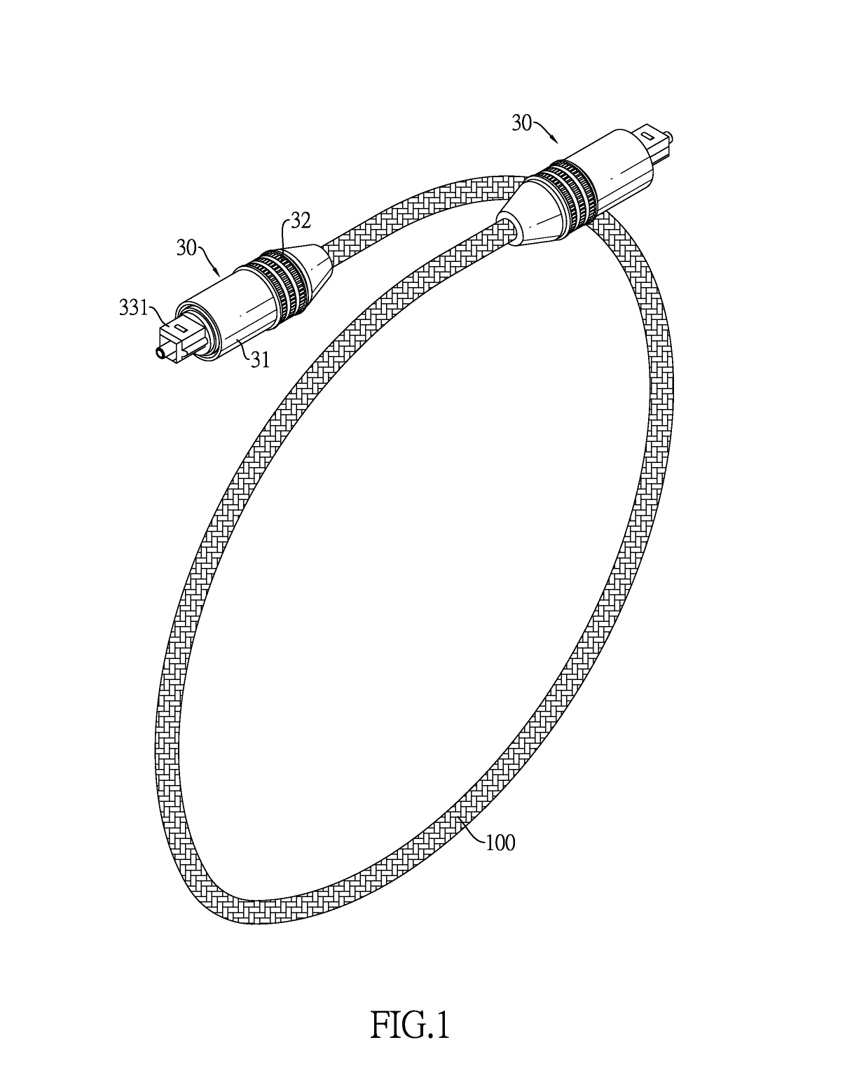

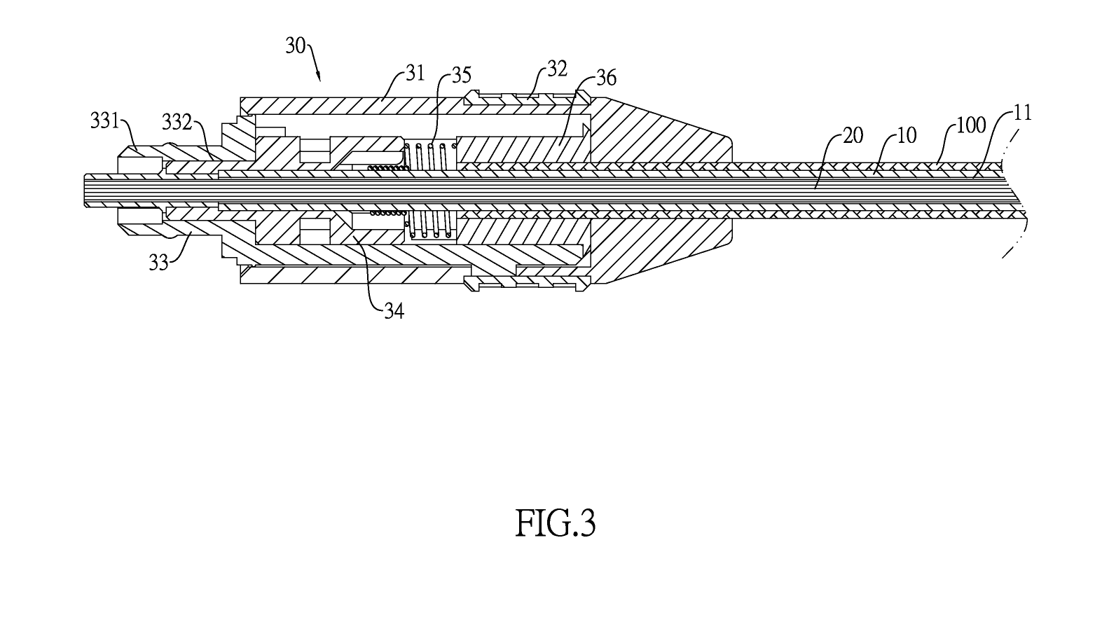

With reference to FIGS. 1 to 3, a Hi-Fi audio signal optical fiber cable comprises a snake tube 10, an optical fiber bundle 20, and two connectors 30. The snake tube 10 has two ends. Each of the two ends of the snake tube 10 has an opening with an inner diameter. The optical fiber bundle 20 has an outer diameter that is smaller than the inner diameter of the snake tube 10. In this embodiment, the snake tube 10 is formed by coiling a strip-shaped metal to have good flexibility and elasticity. Since it is made of metal, the snake tube 10 provides good protection for the optical fiber bundle 20 disposed therein, preventing the optical fiber bundle 20 from deformation or breaking due to squeezing or impacts. Moreover, the snake tube 10 is enclosed by a mesh cover 100 woven from a plastic material such as nylon.

The optical fiber bundle 20 is inserted coaxially inside the snake tube 10. As the outer diameter of the optical fiber bundle 20 is smaller than the inner diameter of the snake tube 10, an air gap 11 is formed between the optical fiber bundle 20 and the snake tube 10 along the radial direction. The air gap 11 is filled with ordinary atmospheric air so that an outer surface of the optical fiber bundle 20 is not completely attached to the inner wall of the snake tube 10. The optical fiber bundle 20 is composed of a plurality of optical fibers 21 in parallel. Both ends of the optical fiber bundle 20 protrude from the openings on the both ends of the snake tube 10. In this embodiment, the optical fiber bundle 20 has the same grade of optical fiber material as industrial optical fiber endoscopes. The number of optical fibers 21 in the optical fiber bundle 20 may be at least 7000. Therefore, the optical fiber bundle 20 has the resolution of at least 7000 pixels for the optical signal from the input end.

Each of the two ends of the optical fiber bundle 20 outside the snake tube 10 has the connector 30. Each of the connectors 30 connects to an optical signal input end or an optical signal output end. In this embodiment, the connector 30 includes an outer case 31, a rubber sleeve 32, an inner case 33, a front connecting element 34, a spring 35, and a rear connecting element 36. The rubber sleeve 32 is mounted around an outer surface of the outer case 31. The inner case 33 is disposed inside the outer case 31. A front end of the inner case 33 is formed with a protruding part 331 protruding from the outer case 31. The protruding part 331 is formed with a hole 332 for the front connecting element 34 to extend out of the inner case 33. One end of the optical fiber bundle 20 goes in sequence through the rear connecting element 36, the spring 35, the front connecting element 34, and the hole 332 of the inner case 33, so that the spring 35 is sandwiched between the front connecting element 34 and the rear connecting element 36.

When the invention is in use, the two connectors 30 are connected to an optical signal input end and an optical signal output end, respectively. When the optical signal output end outputs an optical signal to one end of the optical fiber bundle 20, the optical signal is transmitted through all the optical fibers 21 in the optical fiber bundle 20 by total reflections to the connector 30 at the other end of the optical fiber bundle 20. The output optical signal is received by the optical signal input end.

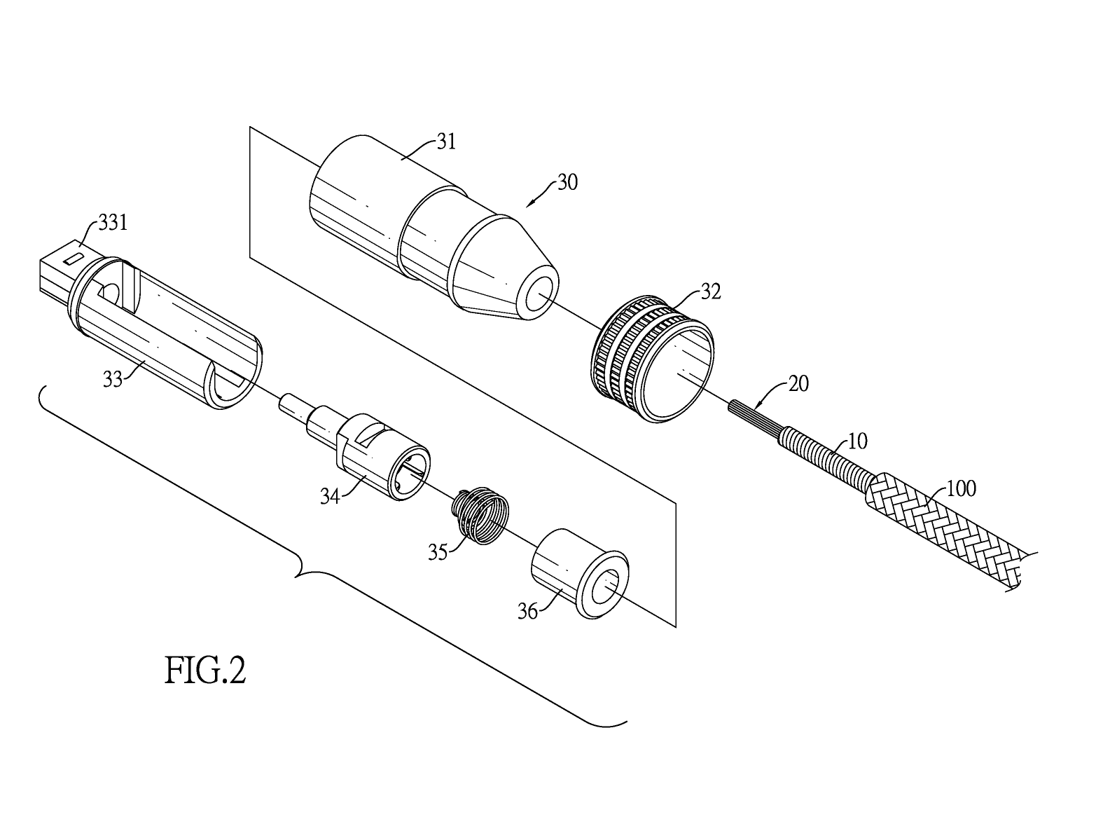

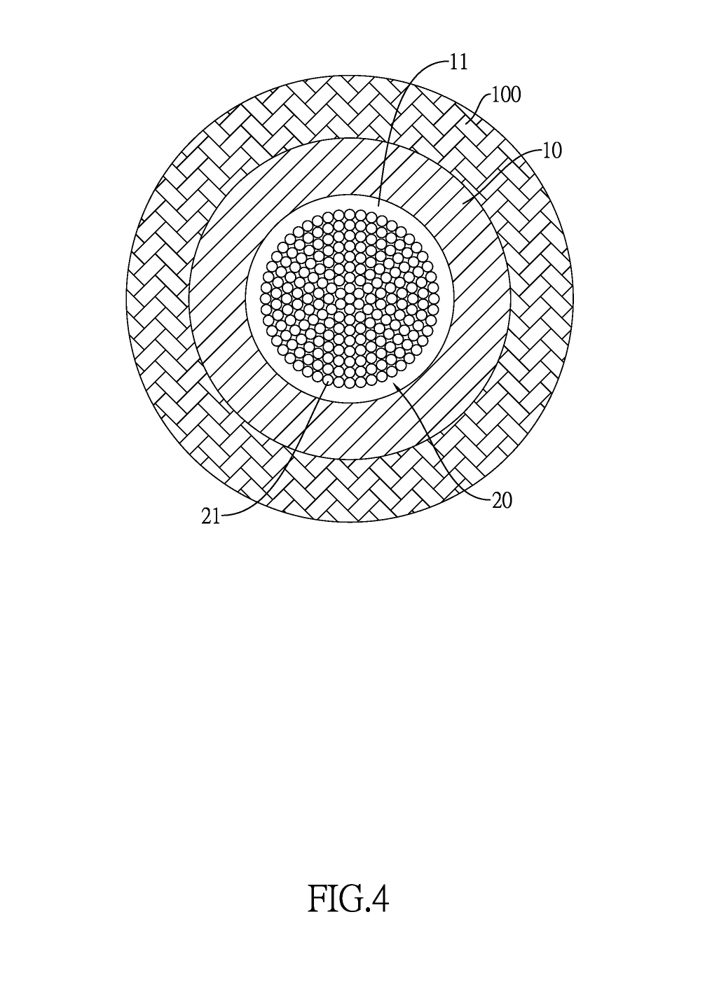

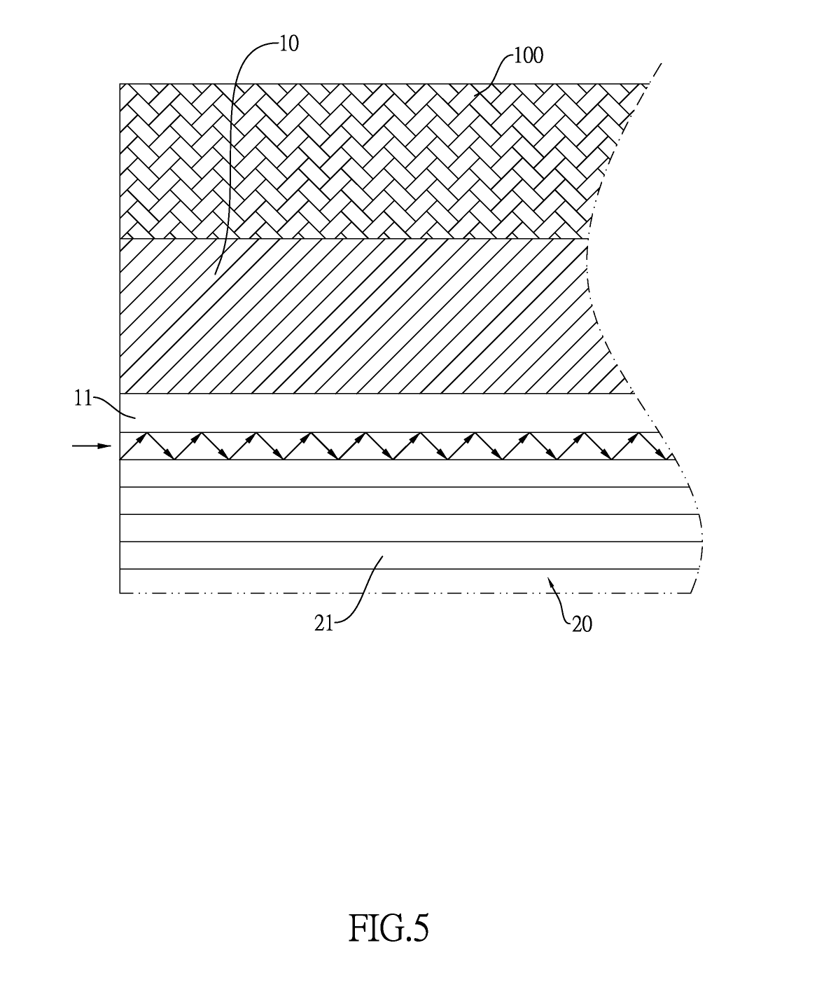

With reference to FIGS. 2 to 5, the air gap 11 is formed between the optical fiber bundle 20 and the snake tube 10 and filled with ordinary atmospheric air so that the optical signal experiences only total reflections without absorption. When part of the optical signal enters one optical fiber 21 of the optical fiber bundle 20, the optical signal travels along the optical fiber 21 and has total reflections from an inner wall of the optical fiber 21. The condition for achieving total reflections depends on the interface between two materials of different refractive indices and the incident angle at the input end. According to the wave-particle duality in quantum physics, the total reflection in optics can be understood as follows. The optical signal entering the optical fiber 21 can be viewed as a photon. Any person skilled in the field of optics should know Snell's Law sufficiently well to derive the critical incident angle to achieve total reflection at the interface between two materials of different refractive indices. With reference to FIG. 5, when a photon goes from a material of refractive index n₁ to another material of refractive index n₂, the critical angle θ_{c} for the photon to have total reflection is:

θ_{c}=arcsin(n₁/n₂).

The numerical value of n₁ has to be smaller than that of n₂. The angle between the incident trajectory of the photon and the normal to the interface has to be greater than the critical angle θ_{c} in order for total reflection to happen. When the incident photon satisfies the total reflection condition, the energy carried by the photon does not have any component in the material of refractive index n₂. That is, the photon energy is completely reflected by the interface back into the material of refractive index n₁. This does not cause any energy dissipation so that the information transmitted from one end of the optical fiber bundle to the other end is not attenuated or distorted. The above-mentioned critical angle formula tells us that the more different n₁ and n₂ are, the smaller the required critical angle θ_{c} for total reflection is received. As a result, the total reflection rate is higher, and the energy dissipation is less.

In this embodiment, the refractive index of each of the optical fibers 21 is about 1.47, and that of ordinary atmospheric air (1 atm, 0□) is about 1.0. The existing audio signal optical fiber cable is coated with a film made of PE, which has a refractive index of about 1.52. It is easily seen that the difference between 1.0 and 1.47 is larger than that between 1.52 and 1.47. Therefore, the critical angle θ_{c} for total reflection in each of the optical fibers 21 of the disclosed optical fiber bundle 20 is smaller, thereby achieving a higher total reflection rate and lower power dissipation. It is thus a feature of the invention to form an air gap 11 between the optical fiber bundle 20 and the snake tube 10. The optical fiber bundle 20 has a refractive index of the standard atmospheric air immediately outside the optical fiber bundle. This ensures less energy consumption between the optical signal input end and the optical signal output end, thereby achieving the goal of high fidelity.

Besides, the optical fiber bundle 20 is comprised of a plurality of optical fibers 21 in parallel. Therefore, each of the optical fibers 21 only needs a smaller numerical aperture for the optical fiber bundle 20 to convey a sufficient amount of information. The smaller numerical aperture renders the optical path in each of the optical fiber 21 shorter. This also helps reducing optical signal attenuation inside the material and avoiding signal distortion.

In summary, the disclosed Hi-Fi audio signal optical fiber cable has the air gap between the optical fiber bundle and the snake tube filled with ordinary atmospheric air. The refractive indices inside the optical fiber bundle and the outside in the radial direction have a significant difference. This facilitates total reflections with no distortion for the optical signals. Moreover, each of the optical fibers of the optical fiber bundle has a smaller numerical aperture to render the optical path of optical signals shorter. This also has the effect of reducing optical signal attenuation inside the material and avoiding signal distortion.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A Hi-Fi audio signal optical fiber cable, comprising:
a snake tube having two opposite openings;
an optical fiber bundle disposed coaxially inside the snake tube and having an air gap formed between the snake tube and the optical bundle along a radial direction, the optical fiber bundle comprising a plurality of optical fibers disposed in parallel and having two ends extending outside the openings on two ends of the snake tube;
two connectors mounted respectively on the two ends of the optical fiber bundle and exposed from the two openings of the snake tube.

2. The Hi-Fi audio signal optical fiber cable as claimed in claim 1, wherein each of the two connectors comprises an outer case, an inner case, a front connecting element, a spring, and a rear connecting element; wherein one end of the optical fiber bundle goes in sequence through the rear connecting element, the spring, the front connecting element, and the inner case such that the spring is sandwiched between the front connecting element and the rear connecting element.

3. The Hi-Fi audio signal optical fiber cable as claimed in claim 2, wherein the inner case is disposed inside the outer case, a front end of the inner case is fog formed with a protruding part protruding from the outer case, and the protruding part is formed with a hole for the front connecting element to extend out.

4. The Hi-Fi audio signal optical fiber cable as claimed in claim 3, wherein each of the two connectors further includes a rubber sleeve mounted around an outer surface of the outer case in the radial direction.

5. The Hi-Fi audio signal optical fiber cable as claimed in claim 1, wherein the optical fiber bundle includes at least 7000 optical fibers.

6. The Hi-Fi audio signal optical fiber cable as claimed in claim 2, wherein the optical fiber bundle includes at least 7000 optical fibers.

7. The Hi-Fi audio signal optical fiber cable as claimed in claim 3, wherein the optical fiber bundle includes at least 7000 optical fibers.

8. The Hi-Fi audio signal optical fiber cable as claimed in claim 4, wherein the optical fiber bundle includes at least 7000 optical fibers.

9. The Hi-Fi audio signal optical fiber cable as claimed in claim 5, wherein the snake tube is formed by coiling a strip-shaped metal.

10. The Hi-Fi audio signal optical fiber cable as claimed in claim 6, wherein the snake tube is formed by coiling a strip-shaped metal.

11. The Hi-Fi audio signal optical fiber cable as claimed in claim 7, wherein the snake tube is formed by coiling a strip-shaped metal.

12. The Hi-Fi audio signal optical fiber cable as claimed in claim 8, wherein the snake tube is formed by coiling a strip-shaped metal.

13. The Hi-Fi audio signal optical fiber cable as claimed in claim 5, wherein the snake tube is further covered with a mesh cover woven from a plastic material.

14. The Hi-Fi audio signal optical fiber cable as claimed in claim 6, wherein the snake tube is further covered with a mesh cover woven from a plastic material.

15. The Hi-Fi audio signal optical fiber cable as claimed in claim 7, wherein the snake tube is further covered with a mesh cover woven from a plastic material.

16. The Hi-Fi audio signal optical fiber cable as claimed in claim 8, wherein the snake tube is further covered with a mesh cover woven from a plastic material.
